(19) United States
(12) Patent Application Publication
(10) Pub. No.: US 2010/0026816 A1
(43) Pub. Date: Feb. 4, 2010

(54) WIRELESS DATA CAPTURE AND SHARING SYSTEM, SUCH AS IMAGE CAPTURE AND SHARING OF DIGITAL CAMERA IMAGES VIA A WIRELESS CELLULAR NETWORK

(76) Inventors: Jonathan Bergstrom, Seattle, WA (US); Mark Drovdahl, Seattle, WA (US); Sinclair Temple, Seattle, WA (US)

Correspondence Address: PERKINS COIE LLP;PATENT-SEA, P.O. BOX 1247, SEATTLE, WA, 98111-1247, US

(21) Appl. No.: 12/182,942

(22) Filed: Jul. 30, 2008

(51) Int. Cl. H04N 5/225; G06Q 30/00

(52) U.S. Cl. 348/207.11; 455/41.2; 455/66.1; 705/30; 455/558; 348/E05.022

(57) ABSTRACT

Described in detail herein are systems and methods for allowing a wireless telecommunications device, such as a cell phone, to wirelessly receive and transmit digital content, such as digital images from a camcorder. Further, the wireless telecommunications device can wirelessly command a digital content capture device. Further, a card may be inserted into a digital content capture device to permit the device to wirelessly send digital content. Further details and features are described herein.

### CROSS-REFERENCE TO RELATED APPLICATION

This application is related to the assignee's concurrently filed U.S. application Ser. No. ______, entitled “WIRELESS DATA CAPTURE AND SHARING SYSTEM, SUCH AS IMAGE CAPTURE AND SHARING OF DIGITAL CAMERA IMAGES VIA A WIRELESS CELLULAR NETWORK AND RELATED TAGGING OF IMAGES” (Attorney Docket No. 31419.8063).

### BACKGROUND

Digital image capture devices, such as digital cameras or camera phones, are ubiquitous. However, billions of digital photographs are “trapped” each year on cameras or personal computers as consumers struggle to share those photos with others. Some web sites have become available to allow users to share their photos, such as Flickr, Picasa, Kodak Gallery, and so forth. These sites, however, require a user to take a set of photos, download them to a personal computer, upload them to a photo-sharing web site, and then provide a notification (such as an email) and authorization for third parties to access and view those photos.

Backwards compatible Secured Digital Input/Output cards (SDIO cards) are now available to help in the photo-sharing process. For example, the Eye-Fi card is an SDIO card that includes semiconductor memory and a IEEE802.11 radio. The card may be inserted into a camera, where images taken by the camera are stored on the card. The radio on the card then allows the user to wirelessly transmit these images to a user's personal computer or web site.

One problem with such a card is that it may be difficult to implement, particularly for users very inexperienced with computers or digital equipment. Further, a user must ensure that her digital camera can accept a particular memory card. Moreover, the user must have a personal computer and be sufficiently knowledgeable in use of that computer in order to use the card. Thus, the ability to serve a variety of people or equipment, tag images, or otherwise manage images is needed.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a system diagram illustrating a suitable implementation of aspects of the invention.

FIG. 2 is a block diagram illustrating a camera wirelessly linked with a mobile phone.

FIG. 3 is a flow diagram illustrating a process for wirelessly routing images from a camera, through the mobile phone, to a network location.

FIG. 4 is a block diagram illustrating a memory card with wireless capabilities and associated software.

FIG. 5 is a flow diagram illustrating a process for wirelessly routing images from the camera using a “prepaid wireless card”.

FIG. 6 is a flow diagram illustrating use of the phone of FIG. 2 to wirelessly control the camera.

FIG. 7 is a representative screenshot illustrating a graphical user interface to manage the handling of digital images under the system of FIG. 1.

The headings provided herein are for convenience only and do not necessarily affect the scope or meaning of the claimed invention.

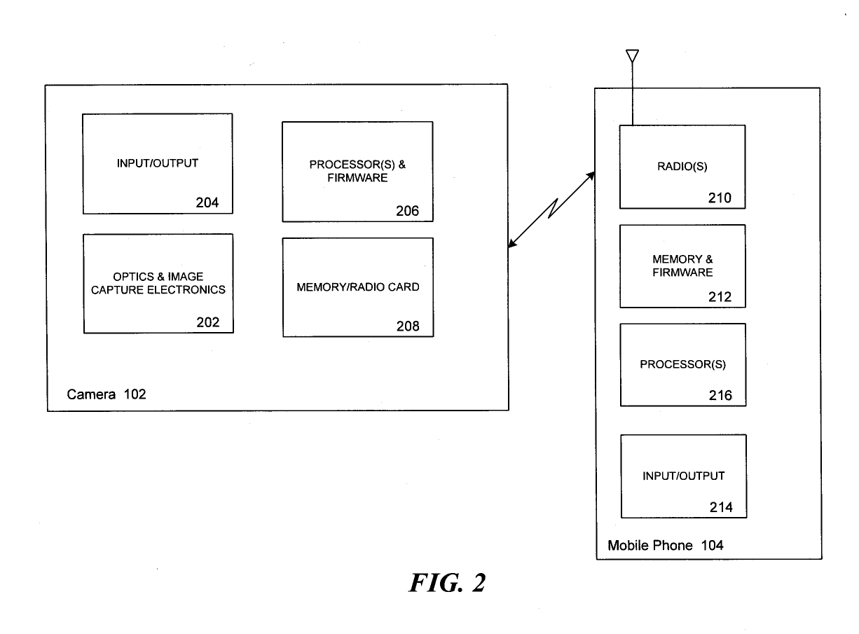

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 204 is first introduced and discussed with respect to FIG. 2).

### DETAILED DESCRIPTION

As described herein, a system permits the sharing of digital content, such as digital images, using a wireless mobile device operating within a wireless network. The wireless device automatically receives captured images under a short-range wireless protocol. The wireless device is logically associated (e.g., “paired”) with a digital content capture device (e.g., digital camera). The wireless device may automatically forward the digital content (e.g., digital image files) to a predetermined network destination (e.g., a URL) without contemporaneous human interaction with the wireless mobile device.

A mobile telecommunications device, such as a cellular phone, a wireless voice-over-IP (VoIP) phone, or a card with embedded radio telecommunications capabilities, may be prepackaged and sold together with a digital content capture device, such as a digital still or video camera, with the two being paired together using a short-range wireless protocol, e.g., Bluetooth. In the case of a digital still or video camera, the camera may obtain higher quality digital images from the digital camera and route them to a predetermined network address, such as a website or web page associated with a user. Data regarding the user, including a specific URL or network address, may be obtained at the point-of-sale.

Also described is an article of manufacture configured to route digital content over a wireless network. The article of manufacture includes a processor, memory, wireless transceiver and stored instructions, all carried on a carrying member or card sized to be received in a memory card slot of, e.g., a digital camera. The instructions can provide authorization for the card to transfer images to a wireless network (e.g., a cellular network), and/or be associated with prepaid authorization to access or use data services of the network.

Furthermore, described in detail below is a system that permits the wireless telecommunications device to wirelessly receive digital data, such a digital image files, obtained from a digital capture device, such as a digital camera or digital camcorder, and to provide user-input commands back to the digital capture device. These commands may, for instance, instruct the camera/camcorder to modify an image, delete an image, identify a network address to route the image, etc.

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention may include other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

### System Description

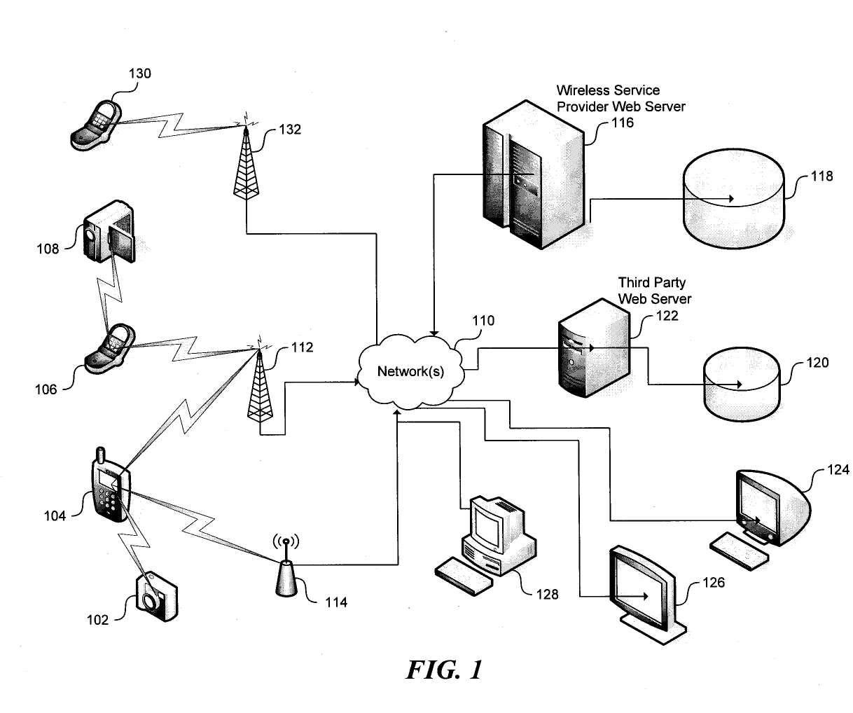

FIG. 1 and the following discussion provide a brief, general description of a suitable environment in which the invention can be implemented. Although not required, aspects of the invention are described below in the general context of computer-executable instructions, such as routines executed by a general-purpose data processing device, e.g., a server computer, wireless device or personal computer. Those skilled in the relevant art will appreciate that the invention can be practiced with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are generally used interchangeably herein, and refer to any of the above devices and systems, as well as any data processor.

While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

As shown in FIG. 1, a digital capture device, in this case a digital camera 102, is wirelessly connected to a wireless telecommunications device, in this case a cellular phone or smartphone 104. Likewise, a cellular phone 106 is wirelessly connected to a video camera or other video-capture device 108. The phones 104, 106 in turn may wirelessly communicate with a network 110 via one or more cellular transceiver(s) or base station(s) 112 within a cellular telecommunications network or other wireless telecommunications network. The cellular telecommunications network may operate at any known standard, such as GSM, CDMA, GPRS, EDGE, UMTS, etc. While the term “phone” is used herein, any wireless telecommunications device capable of performing the functions described herein may be used.

Alternatively or additionally, a wireless telecommunications device, such as phone 104, may communicate with the network 110 via a wireless local area network (WLAN), via a wireless access point (AP) or hotspot 114. The wireless AP 114 may use any known wireless communication protocols, such as IEEE 802.11 or IEEE 802.16. The phone 104 can communicate with the network via the AP 114 via the Unlicensed Mobile Access (UMA) or the Generic Access network (GAN) protocol. The AP 114 typically has a wireless range that is less than that of cellular transceiver 112, but in some embodiments, for instance 802.16 or Wimax, the wireless range may be equal to or exceed that of cellular transceiver 112.

As explained in more detail below, pictures or videos provided by cameras 102, 108 may be wirelessly transmitted to the network 110 via phones 104, 106, where such phones effectively act as modems to pass through the digital content. The network 110 may in turn route the content to a pre-determined location, such as one identified by a Universal Resource Locator (URL). For example, the network may route the images to a web server 116 determined by the user's wireless service provider. The web server 116 in turn stores those images in a database 118, as described below. Likewise, the content may be stored directly in a third party database 120 associated with a third party web server 122, rerouted to database 120 by web server 116, or forwarded directly and in real-time by web server 116 or third party web server 122 to remote content recipients, such as by streaming audio/video to remote locations.

As described in more detail below, the user may access the images stored in databases 118 or 120 via a personal computer 124. The images may also be displayed on an electronic picture frame 126 or a similar display device, or accessed by a third party on a third party computer 128 (typically when first authorized by the user). Likewise, the images may be displayed on a third party mobile device 130, which may be on a different cellular network 132.

### Phone-Camera Pair

Referring to FIG. 2, the camera 102 may be a standard digital camera that includes optics and image capture electronics 202 and input/output components 204, all connected to communicate with one or more processors operating firmware 206. The input/output components may include various buttons or user controls, one or more display screens, audio input and/or output devices, etc. As described more fully below, the camera may also include a removable memory card that includes a wireless radio 208. Of course, the camera may instead include a fixed wireless radio. The removable memory card is received within a card slot of the camera, and can be of a form and shape common to any known cards, such as SD cards, xD cards, PCMCIA cards, etc.

The camera 102 can wirelessly communicate directly or via radio card 208 with a mobile telecommunications device, such as mobile phone 104, which includes one or more radios 210, memory and firmware 212 and input/output components 214 that all communicate with one or more processors 216. The radios can include a CDMA, GSM, GPRS, EDGE or UMTS radio, or prospective 4G technologies such as LTE, as well as a WLAN, and/or personal area network (PAN) radio, such as one employing IEEE 802.11, Bluetooth or other wireless standards. In the example of FIGS. 1 and 2, the camera and phone communicate with each other over a short-range wireless link using any known short-range protocol. Such short-range protocol typically has a range of about 10-50 meters (often under 100 meters), and includes Piconet protocols, including ZigBee, IrDA, and Ultra Wide Band (UWB).

The processors in the phone, the camera or both can include digital signal processors or other components for processing images, facilitating voice and data calls, as well as processors for performing actions described herein. The input/output components of the phone 104 include a microphone, speaker, visual display, user input buttons, as well as other components, such as a global positioning system (GPS), a digital camera, and so forth. While the phone 104 may have its own digital camera, the camera 102 is typically designed specifically for taking higher quality digital images, and thus may have a much higher resolution digital imager, better optics, and so forth. In GSM embodiments, both the phone 104 and the camera 102 may include a removable card slot to receive a Subscriber Identity Module (SIM) as well as a removable memory card that may itself include a radio, as noted herein.

### Representative Process

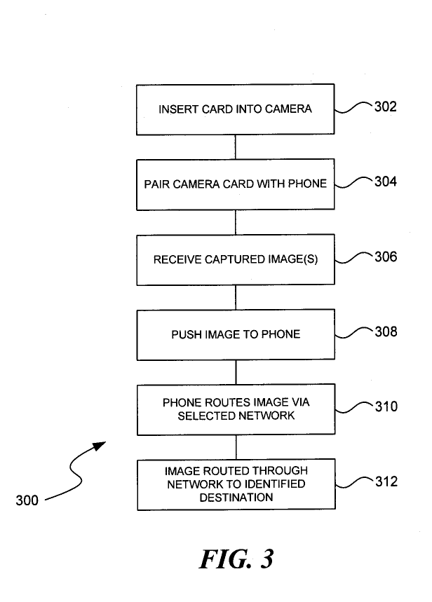

Referring to FIG. 3, a routine 300 performed by the system in FIG. 1 includes, in embodiments including a radio card 208, initially inserting the radio card 208 into the camera 102 if the camera lacks a wireless link (block 302). The phone 104 then pairs itself with the radio card 208, such as using standard Bluetooth pairing. If the camera 102 has radio functionality, the phone 104 can pair with the camera 102 directly. Indeed, the camera/radio card and phone may use any of various Bluetooth profiles, such as the Dial-Up Networking (DUN) or Personal Area Network (PAN) profiles. As a result, the camera/radio card and phone are thereafter paired or linked so that secure communications may be exchanged between the two (block 304). More importantly, the camera, using firmware stored in the camera or within the removable memory/radio card 208, can automatically route digital pictures from the camera to the network and elsewhere via the phone 104.

After receiving a captured image (block 306), the camera, via its radio, transmits the image to the phone 104 (block 308) either by pushing the image to the phone or by responding to a phone request for the image. The phone and/or the camera may encapsulate network routing information or address with the image. For example, the camera (or phone) may add a header to the digital image to route the image to the user's personalized photo album at an Internet site or URL. Thus, the header can take the form of, for example, “http://www.T-Mobile.com/My Album [user ID]”. The user ID may include any unique identifier for the user, such as the user's mobile identification number (MIN), International Mobile Subscriber Identifier (IMSI), International Mobile Equipment Identifier (IMEI), Secret Serial Number (SSN), phone number, Medium Access Control (MAC) address, Globally Unique Identifier (GUID), or any other identifier.

Firmware in the radio card 208 of the camera 102, or in memory 212 of the phone 104, can include a preprogrammed address, as well as instructions, for transmitting the digital image. The address can be a TCP/IP address, with a place for the user, wireless service provider, or other to insert the user's specific identifier. There may also be provisioning for the user, service provider, or other to insert aspects of the address.

The phone routes the image via a selected network (block 310), which can include a cellular telephone network (like CDMA, GSM, GPRS, EDGE or UMTS, or prospective networks such as LTE), or via a local area network employing IEEE 802.11, Bluetooth or other wireless standards. The phone may select the best or preferred network based on any of a variety of criteria, such as availability, signal strength, data transmission cost, and so forth. Indeed, the system can use any type of protocol or transport mechanism, including the Wireless Application Protocol (WAP), Multimedia Message Service (MMS), HyperText Transfer Protocol (HTTP), and so forth. Once received by the network 110, the network routes the images to the specified destination, such as to the web server 116 for storage and database 118 (block 312).

Overall, the image may be routed to any TCP/IP address, which the network 110 then routes to the appropriate destination, such as web server 116. A wireless telecommunications service provider may provide a web site for the user and is typically a media gateway to enable users to manage their photos from a central location. The web server acts as an intelligent intermediary for the digital image gateway and user manipulation of photos. As explained herein, the web server 116 may then in turn relay one or more received images to a third party web server 122. Such third party web servers may be any of various image storing and sharing sites, including Flickr, Facebook, and Picasa. The user can then go to the one or more web sites to access and manage his or her photos, as described herein.

### Radio Card

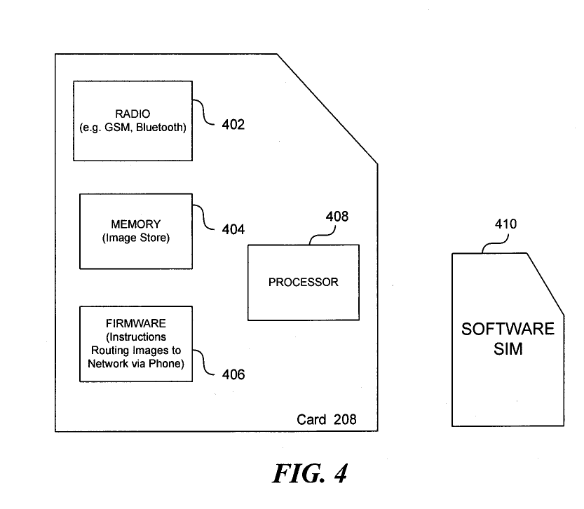

Referring to FIG. 4, the card 208 in the camera 102 may include a radio or wireless transceiver 402, semiconductor memory 404 and firmware 406, all carried or secured to some substantially rigid substrate or other member. As noted above, the radio can be of any form, but in this example is a Bluetooth radio. Alternatively or additionally, the radio can be configured to operate using other protocols, including more powerful protocols such as GSM, GPRS, EDGE, UMTS or CDMA, or prospective protocols like LTE. If a GSM or related protocol, the camera 102 may include, either stored in the memory 404 or elsewhere on the camera, a hardware or software SIM 410 to permit communications over the relevant network. The camera thus acts like a phone on the network, even if it is not configured for voice communications. The camera nevertheless can provide for real time communications, including photo-sharing, as described herein.

The memory 404 can be any semiconductor memory to permit the storing of photos. Notably, this memory need not be as large as is typical with digital camera memory, because the camera need not store images locally. Instead, with the wireless link, the camera can store photos elsewhere, such as in databases 118 or 120. The memory 404, if implemented, simply acts more like a buffer. If not implemented, the card 208 acts as a transceiver for transmitting captured content (in this case, digital images) in real time to the phone 104.

The firmware 406 includes instructions performed by processor 408 to permit the camera to automatically and wirelessly send digital content. When the card 208 is inserted in the camera 102, the camera 102 simply recognizes it as a memory card. However, whenever images are stored in the memory 404, the processor 408, operating on instructions stored in the firmware 406, transfers images from the memory to the phone 104 when the phone 104 is paired to and within range of the card 208. As noted above, the firmware includes an address that the processor includes with each image so that the image is routed appropriately via the network 110.

The card 208 may be sold independently of a camera or other digital capture device. Indeed, it may be sold as a “prepaid card”, where a user can buy such a digital memory card that could be analogized to a disposable camera with prepaid wireless service. The user simply inserts the card 208 into a digital capture device and then automatically send digital content to one or more destinations. For example, the user may purchase the card at a retail location, where the card includes a CDMA, GSM, GPRS, EDGE, UMTS radio, or other radio, and (in GSM embodiments) a software SIM. The card may be activated at the point-of-sale, or may employ over-the-air activation when inserted into a digital capture device and powered up, where customer data may be gathered at the time of sale or soon thereafter (as described below). The user would take pictures, and those pictures would be transferred over a network to a database previously established and associated with that card. The user would then log onto the web server 116 to access the images in the database 118, such as by using a personal identification number (PIN), password, or other information that may be provide at the point-of-sale, obtained from a scratch-off card, and so forth.

Further, the user can access a predefined network location (accessible via the Internet) to rename his or her content home page (e.g., changing it from some arbitrary, but unique, numeric value, to one more personalized to the user's tastes, like “www.T-Mobile.com/MyPhotos/00124758” to “www.T-Mobile.com/MyPhotos/Chrissy's RomePictures”). Of course, the digital content can also be transferred or copied to another site, even to the user's home computer.

Notably, the card 208 has a prepaid wireless data service associated with it to permit the transfer of images over the network to a predefined URL. The card may be associated with a particular wireless service provider, and thus the digital capture device can only transfer content when within range of that service provider's wireless network.

Alternatively or additionally, the card may be usable with any service provider operating a compatible network (when the card has a radio compatible with the alternate service provider). In this instance, a third party may sell the card and enter into agreements with wireless service providers in the geographic area in which sales have occurred. Then, during over-the-air activation that may occur when the card is inserted into the camera and powered up, the card's radio becomes activated on the first contacted network (e.g., strongest received signal). The card 208 may include a unique identifier that the wireless service provider then provides to the third party so that it may receive appropriate compensation or billing from that third party based on the sale. Of course, other arrangements are possible. Overall, this alternative of a prepaid wireless data service card allows users to avoid often more expensive roaming charges if they will be roaming and taking photos in another country.

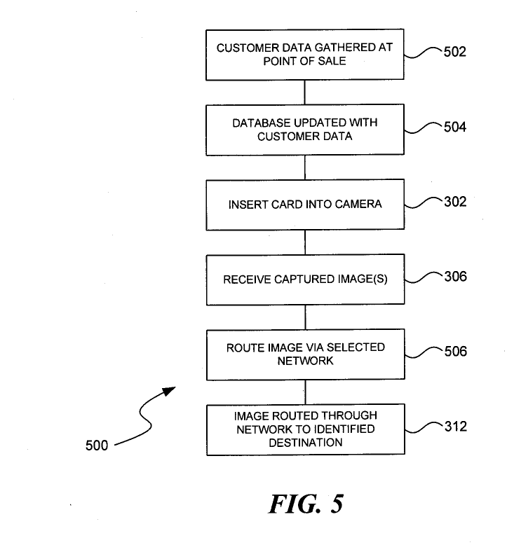

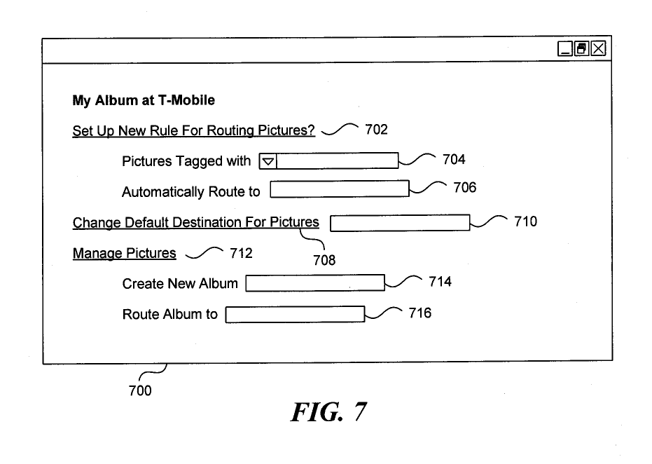

Referring to FIG. 5, a routine 500 illustrates an example of how such a card may be used. Beginning block 502, customer data is gathered at the point of sale, as noted herein. Alternatively or additionally, customer data may be input over the network by a personal computer accessed by the user. In block 504, this input data is then used to update a database record that associates the card with a particular user (FIG. 7). As noted below, the user may be different from the purchaser.

Thereafter, the routine 500 continues in blocks 302 and 306 as described above. In block 506, images taken by the camera 102 may be routed directly from the cell site transceiver 112 and from (in this example), the network to an IP network. Then, the IP network subsequently routes the image to a predetermined or specified logical or network address (e.g., URL) for storage in the database 118. In this example, images are routed directly from the camera 102 for storage in the database, via one or more networks 110; alternatively or additionally, such images may be routed through the phone 104. Alternatively or additionally, while described above as using a cellular network, the card 102 may likewise permit transfer of digital images using a WLAN via AP 114, with the card having a WLAN radio and prepaid wireless access over the WLAN.

The phone 104 and camera/card 102 of FIG. 2 may be packaged together for retail sale, where the phone and camera are configured for out-of-the-box operation with little to no user configuration. The camera and phone unit may, of course, include easy-to-follow instructions, a CD or other computer-readable medium for allowing the user to receive a wizard or simple walk-through menus to set up the camera-phone pair (including designating a particular URL to which images are to be sent), and so forth. The camera-phone unit may include a single stock-keeping unit (SKU).

In this example, the camera/card and phone are previously configured before or at sale such that their two wireless Bluetooth radios recognize the existence of each other's Bluetooth address. When the package is sold at a retail point-of-sale location, a customer service representative or salesperson gathers relevant information from the purchaser, which is then used to initiate wireless service of the phone. The gathered information is combined with other previously programmed information of the devices, so that a single record is created. The record, which may be stored in the database 118, can include the following fields:

| Field | Value |
|---|---|
| IMEI/IMSI | Integer |
| MIN | Integer |
| MAC | Integer |
| First Name | Alphanumeric |
| Last Name | Alphanumeric |
| Street Address | Alphanumeric |
| City | Alphanumeric |
| State | Alphanumeric |
| Postal Code | Alphanumeric |
| Billing Name | Alphanumeric |
| Billing Street Address | Alphanumeric |
| Billing City | Alphanumeric |
| Billing State | Alphanumeric |
| Billing Postal Code | Alphanumeric |
| Email Address | Alphanumeric |
| User Image/Background | Image File |
| Instant Messaging Handle | Alphanumeric |
| User Name Alias | Alphanumeric |
| Phone Model Number | Alphanumeric |
| Camera MAC Address | Integer |
| Camera Model ID | Alphanumeric |
| Photo Web Site URL | Alphanumeric |
| Billing Plan | Alphanumeric |

As shown above, the purchaser of the camera/card-phone package can set up a billing address for a data plan associated with the digital image sharing that differs from that of a user of the package. Further, the purchaser can also establish a specific URL or location to which the images should be routed. This address can replace anything previously programmed in the camera/card or phone, such as during over-the-air activation when the phone and camera/card are first powered up. Thus, for example, a grandparent may purchase the phone and camera/card combination as a gift for a child, so that the child can in turn take pictures of a grandchild and have those pictures automatically sent to a web site designated by the grandparent or to a frame location. A special voice plan and data plan may likewise be established so that the grandparent pays for some or all of one or both plans. These plans, of course, can change over time, have a time limit, and so forth.

### Remote Control of Camera Via Phone

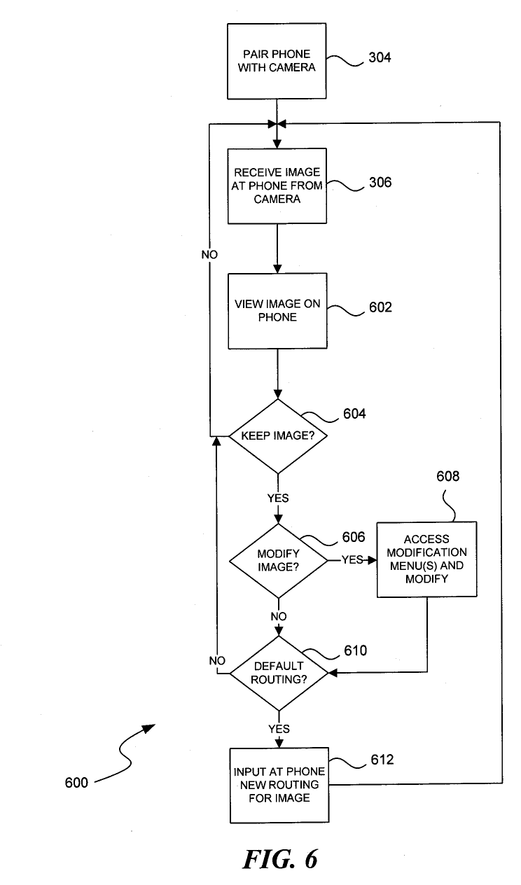

Referring to FIG. 6, a routine 600 for illustrating how the phone 104 can control the camera 102 is shown. Many phones include a user interface that is much more robust than that provided on typical digital cameras. Therefore, using the wireless link between the camera and phone, the phone can control aspects of the camera. This may be done through the use of application programming interfaces (APIs) made available to the phone by the camera, whereby the phone can access software controls of the camera and otherwise control the camera remotely.

The routine 600 begins by pairing the phone with the camera and receiving an image at the phone from the camera under blocks 304 and 306, as described above. In block 602, an image taken by the camera may be viewed on the phone. This may be particularly useful when the visual display on the phone is larger than that of the camera. In block 604, the user can decide whether to keep the image. If the image is kept, then in block 606, the user can determine whether to modify the image. If the user decides to modify the image, then the phone provides access to one or more menus that permit the user to modify the image, such as by changing various attributes of the image (contrast, intensity, sharpness, etc.), applying effects to the image (e.g., red-eye reduction, sepia tones, etc.) and so forth (block 608).

In block 610, the phone may permit the user to change the default routing for the image. For example, the user can, in block 612, select a new destination of the image from a list of available URLs or other network addresses stored on the phone, or permit the user to input a new address. Some phones, particularly smart phones, may include a full alphanumeric keyboard, which can permit much easier user input of a long URL or other network address.

### Web Interface for Managing Photos

Referring to FIG. 7, an example of a web page or screenshot 700 is shown that provides a graphical user interface for users to manage their images. As shown, a link 702 permits a user to set up a new rule for routing pictures, where the link accesses another page (not shown) for providing the user with the ability to adjust or modify details regarding automatic routing for images. However, the screen 700 provides some more common routing features, such as allowing a user to access a list of common metadata tags associated with images from a dropdown list 704 (e.g., date/time tags, location tags, etc.), and have images so tagged to be automatically routed to a specific logical address that may be inserted in box 706.

The user can change the default destination for his or her pictures by accessing a hyperlink 708 that in turn displays a page (not shown) for providing details on a new destination. However, the page 700, for convenience, provides a simple box 710 to allow the user to change the default destination, as noted herein. Likewise, a manage pictures link 712 allows access to a screen or page (not shown) for displaying many options to allow the user to manage pictures. However, the page 700 provides easy access to at least two simple and common management tools, namely the ability to create and name a new album in box 714, or to route an album via box 716. For example, the user may create a new album, insert pictures into that album, and then route the album to a designated location, such as a Facebook or MySpace page.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while aspects of the invention are described above with respect to capturing and routing digital images, any other digital content may likewise be managed or handled by the system provided herein, including video files, audio files, and so forth. While processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for”.) Accordingly, the applicant reserves the right to add additional claims after filing the application to pursue such additional claim forms for other aspects of the invention.

1. A digital content sharing system, wherein the digital content sharing system may be used with a cellular telecommunications network and a Internet Protocol (IP) based computer network, the system comprising:
a digital image capture apparatus comprising:
optics and image capture circuitry,
image capture input and output components,
a short-range wireless transceiver, and
at least one image capture processor coupled to communicate with the optics and image capture circuitry, the image capture input and output components, and the short-range wireless transceiver, and
a first hand-held housing for carrying the optics and image capture circuitry, the image capture input and output components, the short-range wireless transceiver, and the at least one image capture processor; and,
a mobile telecommunications device comprising:
user input and output components,
a first wireless transceiver component for communicating with the short-range wireless transceiver;
a second wireless transceiver component for communicating with the cellular telecommunications network,
at least one processor coupled to communicate with the user input and output components, the first wireless transceiver component, and the second wireless transceiver component, and
a second hand-held housing, separate from the first housing, for carrying the user input and output components, the first wireless transceiver component, the second wireless transceiver component, and the at least one processor;
wherein the cellular telecommunications network has a range greater than that of the short-range wireless transceiver,
wherein the digital image capture apparatus is configured to capture a digital image via the optics and image capture circuitry, and to forward the captured digital image directly to the mobile telecommunications device via the short-range wireless transceiver, and
wherein the mobile telecommunications device is configured to receive the captured digital image via the first wireless transceiver component, and to forward the captured digital image to the cellular telecommunications network via the second wireless transceiver component, wherein the cellular telecommunications network in turn forwards the captured digital image to a designated network address on the IP based computer network.

2. The digital content sharing system of claim 1, wherein the digital image capture apparatus is a digital camera, wherein the short-range wireless transceiver is formed on a removable card received within a memory card slot of the digital camera, and wherein the short-range wireless transceiver includes a Bluetooth radio, and
wherein the mobile telecommunications device is a cell phone, wherein the first wireless transceiver component includes a Bluetooth radio paired to the digital camera's Bluetooth radio, wherein the network address is a universal resource locator (URL), and wherein the IP based computer network is the World Wide Web.

3. The digital content sharing system of claim 1, wherein the digital image capture apparatus and the mobile telecommunications device are packaged together as a single unit, and
wherein the digital image capture apparatus and the mobile telecommunications device are preconfigured as logically paired together to exchange communications.

4. The digital content sharing system of claim 1, wherein the digital image capture apparatus is a digital camera configured to capture still images, video images, or both,
wherein the mobile telecommunications device is a cellular phone having an integrated digital camera, and
wherein the digital camera produces higher resolution or higher quality images than the cellular phone's digital camera.

5. A method of sharing digital content using a wireless telecommunications device, wherein the wireless telecommunications device operates on a wireless telecommunications network, the method comprising:
at the wireless telecommunications device, automatically and directly receiving captured digital content using a short-range wireless protocol,
wherein the wireless telecommunications device is logically associated with a digital content capture device that is in wireless range of the wireless mobile device under the short-range wireless protocol, and,
automatically forwarding the digital content, using the wireless telecommunications device, to a predetermined network destination,
wherein the forwarding is done using the wireless telecommunications network and without contemporaneous human interaction with the wireless telecommunications device, and
wherein the predetermined network destination is associated with a user of the wireless telecommunications device.

6. The method of claim 5 wherein the wireless telecommunications network is a cellular telecommunications network, wherein the telecommunications device is a cellular phone, wherein the digital content is a digital photo captured via a digital camera, wherein the short-range wireless protocol is the Bluetooth protocol, and wherein the predetermined network destination is accessible over a TCP/IP network via a Universal Resource Locator (URL).

7. The method of claim 5, further comprising:
pairing the wireless telecommunications device with a digital camera under the Bluetooth protocol; and,
employing the Dial-Up Networking (DUN) or Personal Area Network (PAN) profile under the Bluetooth protocol to receive the digital content at the wireless telecommunications device from the digital camera.

8. The method of claim 5, further comprising:
detecting multiple wireless networks, wherein the wireless networks include the wireless telecommunications network and a wireless local area network (WLAN); and,
automatically forwarding the digital content via the WLAN.

9. The method of claim 5 wherein the predetermined network location is associated with an electronic picture frame.

10. The method of claim 5 wherein the predetermined network location comprises encapsulating a logical network address with the digital content, and wherein the logical address is associated with a web page for the user and related to an operator of the wireless telecommunications network.

11. The method of claim 5 wherein the digital content comprises an audio file.

12. The method of claim 5 wherein the automatically forwarding includes adding a user identifier, wherein the user identifier comprises: a mobile identification number (MIN), International Mobile Subscriber Identifier (IMSI), International Mobile Equipment Identifier (IMEI), Secret Serial Number (SSN), phone number, Medium Access Control (MAC) address, or Globally Unique Identifier (GUID).

13. The method of claim 5, wherein the wireless telecommunications network is an IP-based wireless telecommunications network.

14. The method of claim 5, wherein the short-range wireless protocol differs from a protocol used within the wireless network.

15. An apparatus configured for sharing digital content within a wireless network, the apparatus comprising:
means for logically associating with a digital content capture device, wherein the digital content capture device is within wireless range under a short-range wireless protocol;
means for automatically receiving captured digital content using the short-range wireless protocol; and,
means for automatically forwarding the digital content to a predetermined network destination,
wherein the means for forwarding employs the wireless network, and
wherein the predetermined network destination is associated with a user of the apparatus.

16. A method of routing still digital images, moving digital images, or both, within a wireless network, the method comprising:
receiving a wireless transceiver card,
wherein the wireless transceiver card includes a processor, a wireless transceiver, and instructions executed by the processor for wirelessly transmitting digital images to a predetermined network address via the wireless transceiver,
wherein the wireless transceiver card is configured to be received within a memory card slot of a digital camera or digital video camera and is configured to be recognized by the digital camera or digital video recorder as a memory card to receive digital images for storage, and,
wherein the wireless transceiver employs at least one protocol compatible with a protocol employed by the wireless network; and
automatically forwarding digital images to the predetermined network address, via the wireless transceiver and the wireless network,
wherein the wireless transceiver card is associated with prepaid authorization to access or use the wireless network.

17. The method of claim 16 wherein the wireless network is a wireless telephone network, and wherein the wireless transceiver of the wireless transceiver card includes at least one of a GSM radio, a GPRS radio, an EDGE radio, a UMTS radio, an LTE radio, an 802.11 radio, an 802.16 radio, and a CDMA radio.

18. The method of claim 16, further comprising receiving customer data during or after purchase of the wireless transceiver card, wherein the customer differs from a user of the wireless transceiver card, wherein the customer data includes obtaining a billing address for the customer that differs from a billing address of the user, and wherein the customer data further includes a new predetermined network address that replaces the predetermined network address.

19. The method of claim 16, further comprising receiving customer data during or after purchase of the wireless transceiver card.

20. The method of claim 16, further comprising performing or receiving over-the-air activation of the wireless transceiver card with the wireless network during or after initial power up of the wireless transceiver card, wherein the wireless network is a wireless telephone network, and wherein the wireless transceiver card includes identification information to authorize access to the wireless network.

21. The method of claim 16 wherein the wireless transceiver card incorporates a semiconductor memory for at least temporarily storing the digital images captured by the digital camera or digital video camera.

22. An article of manufacture configured to route, via a wireless telecommunications network, still digital images, moving digital images, or both, from a digital camera or digital camcorder, the article of manufacture comprising:
a combined memory and wireless transceiver card, comprising:
a processor,
a semiconductor memory, wherein the memory includes a first memory portion for storing digital images, and a second memory portion for storing instructions,
a wireless transceiver, wherein the wireless transceiver employs at least one protocol compatible with a protocol employed by the wireless telecommunications network,
routing instructions stored in the second memory portion and executed by the processor to wirelessly transmit digital images stored in the first memory portion to a predetermined network address via the wireless transceiver,
network instructions stored in the second memory portion and executed by the processor to permit the wireless transceiver to communicate network identification information to the wireless telecommunications network for authorization by the wireless telecommunications network, and,
a carrying member for carrying the processor, memory and wireless transceiver, wherein the carrying member is sized and configured to be received within a memory card slot of the digital camera or digital camcorder and to be automatically recognized as a memory card to receive digital images for storage.

23. The article of manufacture of claim 22 wherein the predetermined network address is a TCP/IP-based URL.

24. The article of manufacture of claim 22 wherein the network identification information is associated with prepaid authorization to access or use data services, but not voice services, of the wireless telecommunications network.

25. The article of manufacture of claim 22 wherein the network instructions include a software-based Subscriber Identity Module (SIM).

26. An article of manufacture configured to route, via a wireless network, digital content from a digital content capture device, the article of manufacture comprising:
a combined memory and wireless transceiver card, comprising:
a processor,
a memory,
a wireless transceiver, wherein the wireless transceiver employs at least one protocol compatible with a protocol employed by the wireless network,
first instructions stored in the memory and executed by the processor to wirelessly transmit digital images stored in the memory via the wireless transceiver,
second instructions stored in the second memory portion and executed by the processor to permit the wireless transceiver to communicate identification information to the wireless network for authorization to use or access the wireless network,
wherein the identification information is associated with prepaid authorization to access or use data services of the wireless network, and,
a carrying member for carrying the processor, memory and wireless transceiver, wherein the carrying member is sized and configured to be received within a memory card slot of the digital content capture device and to be recognized as a memory card to receive digital content for storage.

27. The article of manufacture of claim 26 wherein the wireless network is a GSM, GPRS, EDGE, UMTS, LTE or CDMA-based cellular network and wherein the wireless transceiver and second instructions are configured to permit exchange of data via the cellular network.

28. An article of manufacture, wherein the article of manufacture comprises a computer-readable medium carrying instructions for use by a wireless telecommunications device, wherein the instructions, when executed by the wireless telecommunications device permit the device to perform a method, the method comprising:
wirelessly receiving at the wireless telecommunications device still digital images, moving digital images, or both, directly from a digital camera or digital camcorder;
displaying the received images at the wireless telecommunications device;
receiving at the wireless telecommunications device at least one user-input command affecting at least one of the received digital images; and,
wirelessly transmitting to the digital camera or digital camcorder, from the wireless telecommunications device, the user-input command, wherein the digital camera or digital camcorder in turn performs locally at the digital camera or digital camcorder the transmitted user-input command from the wireless telecommunications device.

29. The article of manufacture of claim 28 wherein the wireless telecommunications device is a cellular phone, wherein the cellular phone is configured to communicate with both a cellular network using a longer range cellular network protocol and with the digital camera or digital camcorder using a shorter range wireless protocol, and wherein the wirelessly transmitting includes wirelessly transmitting to the digital camera or digital camcorder the user-input command using the shorter range wireless protocol.

30. The article of manufacture of claim 28 wherein the user-input command is a command to modify or delete at least one of the received digital images at the digital camera or digital camcorder.

31. The article of manufacture of claim 28, further comprising wirelessly transmitting at least one received digital image to a wireless network, and wherein the user-input command includes inputting a new network address for routing the at least one digital image.
